(19) United States
(12) Patent Application Publication
(10) Pub. No.: US 2003/0094072 A1
(43) Pub. Date: May 22, 2003

(54) Foldable pedal structure for a bicycle

(76) Inventor: Ting-Hsing Chen, Tainan Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/988,091

(22) Filed: Nov. 19, 2001

(51) Int. Cl. G05G 1/14

(52) U.S. Cl. 74/594.4

(57) ABSTRACT

A foldable pedal structure for a bicycle comprises a linking rod having a recess at one end, a pedal, an axle, a pin, a spring and a washer. The linking rod comprises a recess at one end. The pedal has its inner end connected to the linking rod, while the outer end has a hole for the pin to insert through the hole, the spring, and be secured with the washer from the other end. The pin has an enlarged end which is larger in diameter than the hole so that it may stick inside of the hole, which is linked with the linking rod, when pulling the pin away from the hole of the recess; the pedal is able to be folded, accordingly.

### BACKGROUND OF THE INVENTION

1. Field of the Invention

This invention relates to a structure of a bicycle pedal, and more particularly to a pedal which is able to be folded for storage.

2. Description of the Prior Art

A conventional bicycle has its pedals secured to linking rods for easy to step on, however, they are not foldable, thus, not convenient in carry nor in storage.

In view of this, the inventor has derived the present invention, which is able to secure the pedal to the linking rod when riding on the bicycle and to fold the pedal when carrying or storage.

### SUMMARY OF THE INVENTION

It is the primary object of the present invention to provide a foldable pedal of a bicycle, which comprises a linking rod having a recess at one end, a pedal, an axle, a pin, a spring and a washer. The pedal has its inner end connected to the linking rod, while the outer end has a hole for the pin to insert through the hole, the spring, and be secured with the washer from the other end. The pin has an enlarged end which is larger in diameter than the hole so that it may stick inside of the hole, which is linked with the linking rod. When pulling the pin away from the hole of the recess; the pedal can be folded, accordingly.

It is another object of the present invention to provide a foldable pedal structure for a bicycle, which is easy to operate.

It is a further object of the present invention to provide a foldable pedal structure for a bicycle, which saves space to store and is easy to carry.

### BRIEF DESCRIPTION OF THE DRAWINGS

FIG. 1 is a top view of the present invention with partially sectioned;

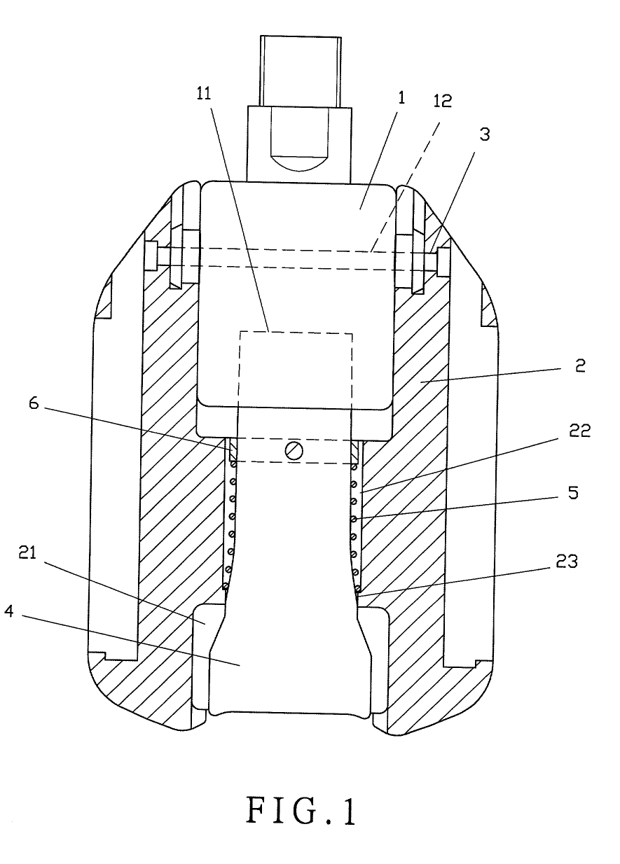

FIG. 2 is a side elevation view of the present invention;

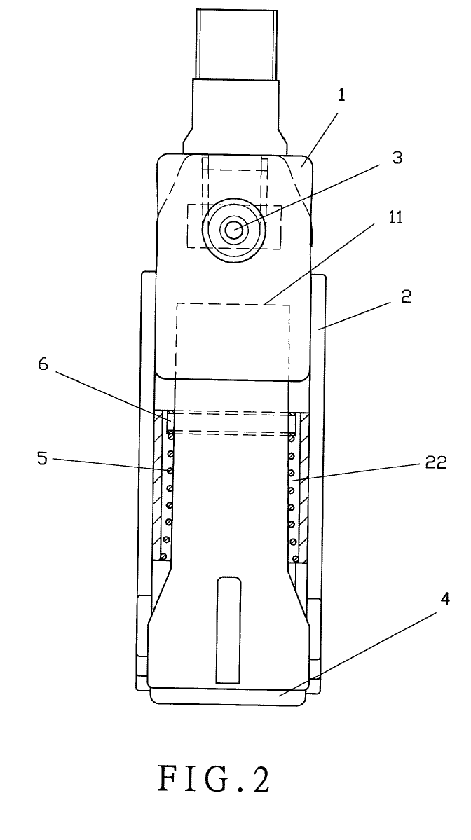

FIG. 3 is a top view of the present invention with partial sectioned;

FIG. 4 is a side view of the present invention, before the pedal are folded; and

FIG. 5 is a side view of the present invention, with the pedal folded.

### DETAILED DESCRIPTION OF THE PREFERRED EMBODIMENT

The foldable pedal structure for a bicycle of the present invention comprises a linking rod 1, a pedal 2, an axle 3, a pin 4, a spring 5, and a washer 6.

The linking rod 1 has a recess 11 at one end, and a transverse hole 12 close to the recess 11.

The pedals 2 has a notch 21 at one end with a hole 22 at the inner end of the notch 21, a barrel 23 is formed from the inner edge of the hole 22 and extending inwardly.

The pin 4 has an enlarged end which is larger in diameter than the hole 22. The notch 21 is to accommodate the pin 4 with its enlarged end exposed there from.

Thus, the inner end of the pedal 2 is secured to the transverse hole 12 of the linking rod 1 by the axle 3, and the pin 4 is inserted through the hole 22 of the pedal 2, the spring 5 and secured by the washer 6 which may be slid in the barrel 23. Due to the enlarged end of the pin 4 is larger in diameter than the hole 22, the pin 4 is inserted and engaged into the recess 11 of the linking rod 1.

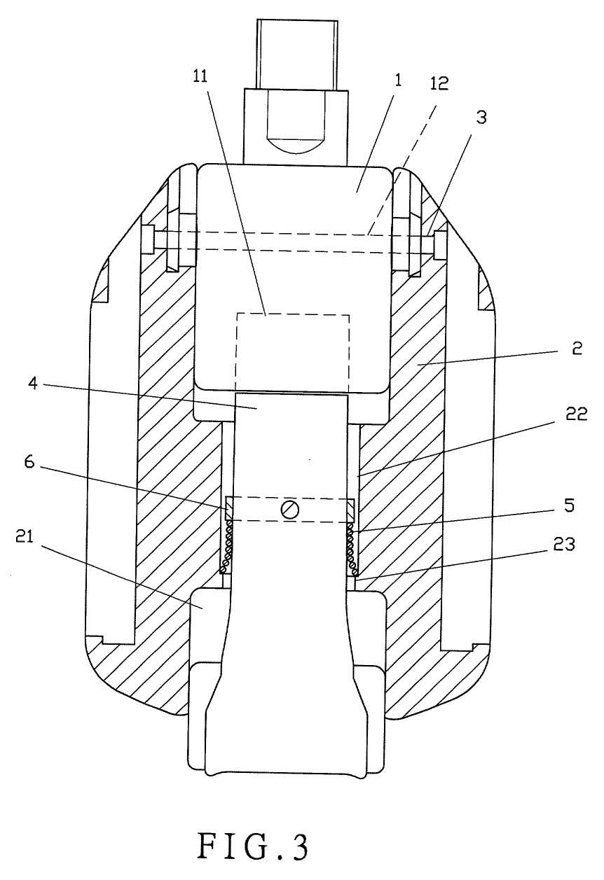

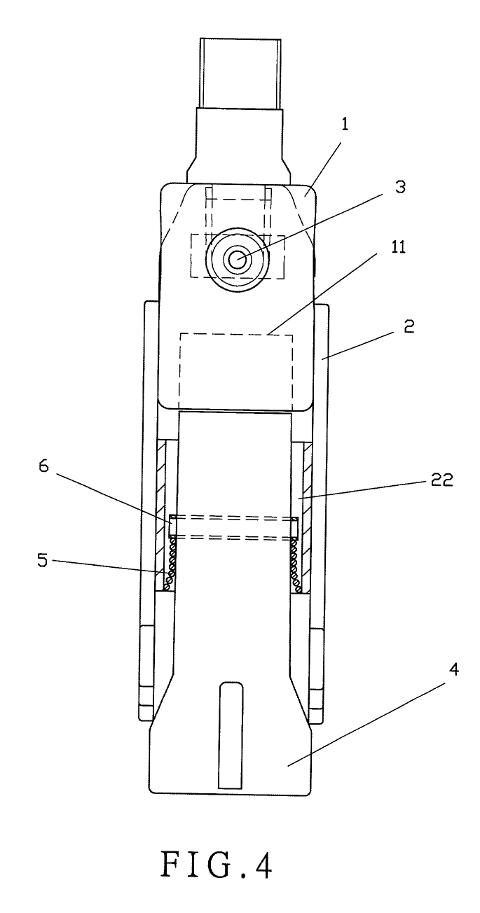

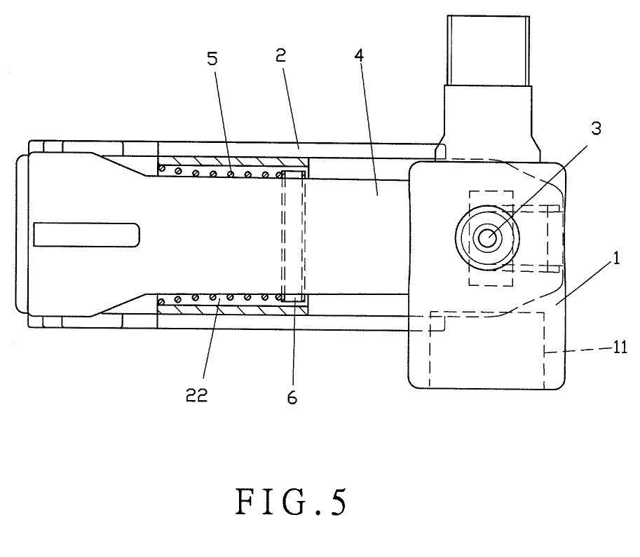

To operate the present invention, as shown in FIGS. 3 through 5, when pulling the pin 4 away from the recess 11 of the pedal 2, the pedal 2 may be folded.

I claim:

1. A foldable pedal structure for a bicycle comprising a linking rod, a pedal, an axle, a pin, a spring and a washer, wherein said linking rod comprising a recess at one end, an inner end of said pedal being connected to one end of said linking rod by said axle, the outside of said pedal comprising a hole for said pin to be inserted therein, and then a spring and then secured by a washer from the other end, whereas when pulling the pin away from said recess of said pedal, said pedal being able to be folded.

2. The foldable pedal for a bicycle, as recited in claim 1, wherein said pedal has a notch at its outer end and a hole at the inner end of said notch, said notch is adapted to receive a larger end of said pin.

3. The foldable pedal for a bicycle, as recited in claim 1, wherein said pedal comprises a barrel from the inner edge of said pedal and has extending a hole from said inner side for said pin to slide within said notch.
